(19) United States
(12) Patent Application Publication
(10) Pub. No.: US 2020/0388270 A1
(43) Pub. Date: Dec. 10, 2020

(54) SPEECH SYNTHESIZING DEVICES AND METHODS FOR MIMICKING VOICES OF CHILDREN FOR CARTOONS AND OTHER CONTENT

(71) Applicant: Sony Corporation, Tokyo (JP)

(72) Inventors: Brant Candelore, Escondido, CA (US); Mahyar Nejat, San Diego, CA (US)

(21) Appl. No.: 16/432,660

(22) Filed: Jun. 5, 2019

(51) Int. Cl. G10L 15/06; G10L 13/04; G10L 15/16

(52) U.S. Cl. CPC G10L 15/063; G10L 15/16; G10L 13/04

(57) ABSTRACT

Speech synthesizing devices and methods are disclosed for mimicking the voices of real-life children in cartoons and other content. A text-to-speech deep artificial intelligence model can be used to do so, with the model being trained using audio recordings of the child speaking as well as text corresponding to the words that are spoken by the child in the audio recordings. The model may then be used to produce various audio outputs in the voice of the child that are inserted into the cartoon or other content, either into vacant portions of the content and/or as replacement for existing audio of the content.

### FIELD

The present application relates to technically inventive, non-routine text-to-speech solutions that are necessarily rooted in computer technology and that produce concrete technical improvements.

### BACKGROUND

Currently, many computer-generated AV contents are difficult for children to understand owing to the automated and robotic-sounding voices that are employed by text-to-speech systems to generate audio for the content. Furthermore, sometimes those computer-generated voices use an accent or unfamiliar tone that makes it even more difficult for children to understand the audio of the AV content. There are currently no adequate solutions to the foregoing computer-related, technological problem.

### SUMMARY

Present principles involve using speech synthesizing devices and methods to duplicate the voices of children (including e.g., their accents, tones, etc.). A text-to-speech artificial intelligence model including a deep neural network (DNN) can be used to do so, where the DNN may be trained using audio recordings of a given child speaking as well as text corresponding to the words that are spoken by the child in the audio recordings. The DNN may then be used to produce various other audio outputs in the voice of the child for insertion into cartoons and other pieces of audio video (AV) content.

Accordingly, in one aspect an apparatus includes at least one computer memory that is not a transitory signal and that includes instructions executable by at least one processor to access an artificial intelligence model trained to mimic the voice of a child and to access closed captioning (CC) text associated with a piece of audio visual (AV) content. The instructions are also executable to use the artificial intelligence model and the CC text to insert audio mimicking the voice of the child into the piece of AV content, with the audio including an audible representation of the CC text.

The piece of AV content may be an AV cartoon. Furthermore, the artificial intelligence model may include a deep neural network (DNN) that is trained to mimic the voice of the child, where the DNN may be trained based on recorded speech of the child and text corresponding to the recorded speech.

Additionally, the instructions may be executable to receive the AV content from a content provider and insert, locally at the apparatus, the audio into the piece of AV content.

Thus, in some example embodiments the apparatus may be embodied in a server. The instructions may be executable to receive the AV content from the content provider with at least one audio segment of the AV content being left vacant and to transmit, to another device, the piece of AV content with the audio inserted into the at least one vacant audio segment. Additionally or alternatively, the instructions may be executable to receive the AV content from the content provider with no audio segments of the AV content being left vacant and to transmit, to another device, the piece of AV content with the audio replacing at least a first audio segment of the AV content received from the content provider.

In other example embodiments, the apparatus may be embodied in a consumer electronics device of an end user, and the instructions may be executable to receive the AV content from the content provider with at least one audio segment of the AV content being left vacant. If desired, the instructions may also be executable to remaster the AV content locally at the apparatus prior to presentation of the AV content locally at the apparatus, where the AV content may be remastered with the audio being inserted into the at least one vacant audio segment. The instructions may then be executable to subsequently begin presenting the remastered AV content locally at the apparatus. Additionally or alternatively, the instructions may be executable to receive the AV content from the content provider with no audio segments of the AV content being left vacant, to insert the audio into the piece of AV content at least in part by replacing at least a first audio segment of the AV content, and to remaster the AV content locally at the apparatus prior to presentation, where the first audio segment may be received from the content provider as part of the AV content.

Still further, in some examples the instructions may be executable to stream the AV content from another device and insert the audio into the piece of AV content as the piece of AV content is streamed and presented. If desired, the apparatus may insert the audio into the piece of AV content as the piece of AV content is streamed and presented by one or more of inserting the audio into at least one vacant audio segment of the AV content and replacing at least one filled audio segment of the AV content.

Furthermore, in some embodiments the apparatus may include the at least one processor itself.

In another aspect, a method includes accessing a speech synthesizer trained to mimic the voice of a child, where the speech synthesizer includes an artificial neural network trained to the child's voice based on recorded speech of the child and first text corresponding to words indicated in the recorded speech. The method also includes accessing second text associated with audio visual (AV) content and using the speech synthesizer and the second text to insert audio mimicking the voice of the child into the AV content.

In still another aspect, an apparatus includes at least one computer readable storage medium that is not a transitory signal. The at least one computer readable storage medium includes instructions executable by at least one processor to use a trained deep neural network (DNN) to produce a representation of a child's voice as speaking audio corresponding to at least a portion of the script of audio video (AV) content. The trained DNN is trained using both at least one recording of words spoken by the child and text corresponding to the words, where the text is different from the script.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example illustration of a child observing AV content that includes a character speaking in the voice of the child consistent with present principles;

FIG. 3 is an example block diagram of a text-to-speech synthesizer consistent with present principles;

FIG. 4 is a flow chart of example logic for using a DNN to insert audio into AV content that mimics the voice of a child consistent with present principles; and

FIG. 5 is an example graphical user interface (GUI) for a user to configure settings of a device operating according to present principles.

### DETAILED DESCRIPTION

In accordance with the present disclosure, devices are able to change the voice of, for example, a character in a cartoon in order to duplicate the voice of a specific child in a household to “place” the child in the cartoon (or other feature film). The voice of the child may be characterized ahead of time by having the child say a certain number of selected phrases and configuring a text-to-speech artificial intelligence model accordingly. The cartoon could then be ordered or downloaded with the voice changes already done, or the base copy of the movie (e.g., original copy) could be streamed or downloaded with the TV or content player performing the text-to-speech (TTS) operation locally. Text may be accessed that is associated with the dialogue of the cartoon to determine which words to audibly produce in the voice of the child, where the text-to-speech engine would use the text to recreate the dialogue in the voice of the child. Additionally, in some examples the dialogue of the other characters in the cartoon may also be dubbed in with other respective human voices, such as a synthetic version of the voice of the child's parent. In any case, the text may be from closed captioning (CC) dialogue or other sources such as a script of the cartoon, where the script/CC may also indicate which words are spoken by the child's character so that the device knows which text to audibly reproduce in the voice of the child. The script/CC may further indicate audible pauses and emphasis on certain syllables and certain words to more effectively simulate the real-life child's voice for the character so that the audio remains consistent with the original audio of the cartoon.

This disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

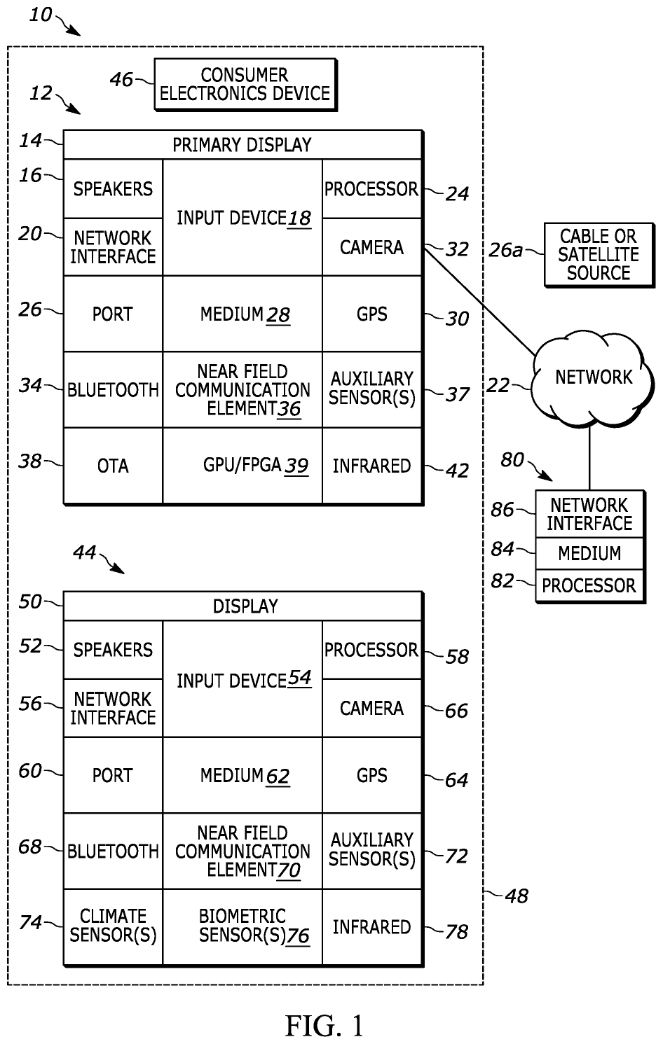

Now specifically referring to FIG. 1, an example ecosystem 10 is shown, which may include one or more of the example devices mentioned above and described further below in accordance with present principles. The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for communication over at least one network 22 such as the Internet, an WAN, an LAN, a PAN etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 38 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) and/or a field-programmable gate array (FPGA) 39. The GPU and/or FPGA 39 may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 44 and a second device 46 are shown and may include similar components as some or all of the components of the AVDD 12. Fewer or greater devices may be used than shown.

In the example shown, to illustrate present principles all three devices 12, 44, 46 are assumed to be members of a local network in, e.g., a dwelling 48, illustrated by dashed lines.

The example non-limiting first device 44 may include one or more touch-sensitive surfaces 50 such as a touch-enabled video display for receiving user input signals via touches on the display. The first device 44 may include one or more speakers 52 for outputting audio in accordance with present principles, and at least one additional input device 54 such as e.g. an audio receiver/microphone for e.g. entering audible commands to the first device 44 to control the device 44. The example first device 44 may also include one or more network interfaces 56 for communication over the network 22 under control of one or more processors 58. Thus, the interface 56 may be, without limitation, a Wi-Fi transceiver, which is an example of a wireless computer network interface, including mesh network interfaces. It is to be understood that the processor 58 controls the first device 44 to undertake present principles, including the other elements of the first device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first device 44 may also include one or more input ports 60 such as, e.g., a HDMI port or a USB port to physically connect (e.g. using a wired connection) to another computer device and/or a headphone port to connect headphones to the first device 44 for presentation of audio from the first device 44 to a user through the headphones. The first device 44 may further include one or more tangible computer readable storage medium 62 such as disk-based or solid-state storage. Also in some embodiments, the first device 44 can include a position or location receiver such as but not limited to a cellphone and/or GPS receiver and/or altimeter 64 that is configured to e.g. receive geographic position information from at least one satellite and/or cell tower, using triangulation, and provide the information to the device processor 58 and/or determine an altitude at which the first device 44 is disposed in conjunction with the device processor 58. However, it is to be understood that that another suitable position receiver other than a cellphone and/or GPS receiver and/or altimeter may be used in accordance with present principles to e.g. determine the location of the first device 44 in e.g. all three dimensions.

Continuing the description of the first device 44, in some embodiments the first device 44 may include one or more cameras 66 that may be, e.g., a thermal imaging camera, a digital camera such as a webcam, etc. Also included on the first device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first device 44 may include still other sensors such as e.g. one or more climate sensors 74 (e.g. barometers, humidity sensors, wind sensors, light sensors, temperature sensors, etc.) and/or one or more biometric sensors 76 providing input to the device processor 58. In addition to the foregoing, it is noted that in some embodiments the first device 44 may also include an infrared (IR) transmitter and/or IR receiver and/or IR transceiver 42 such as an IR data association (IRDA) device. A battery may be provided for powering the first device 44. The device 44 may communicate with the AVDD 12 through any of the above-described communication modes and related components.

The second device 46 may include some or all of the components described above.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers, controllers, and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

The devices described below may incorporate some or all of the elements described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

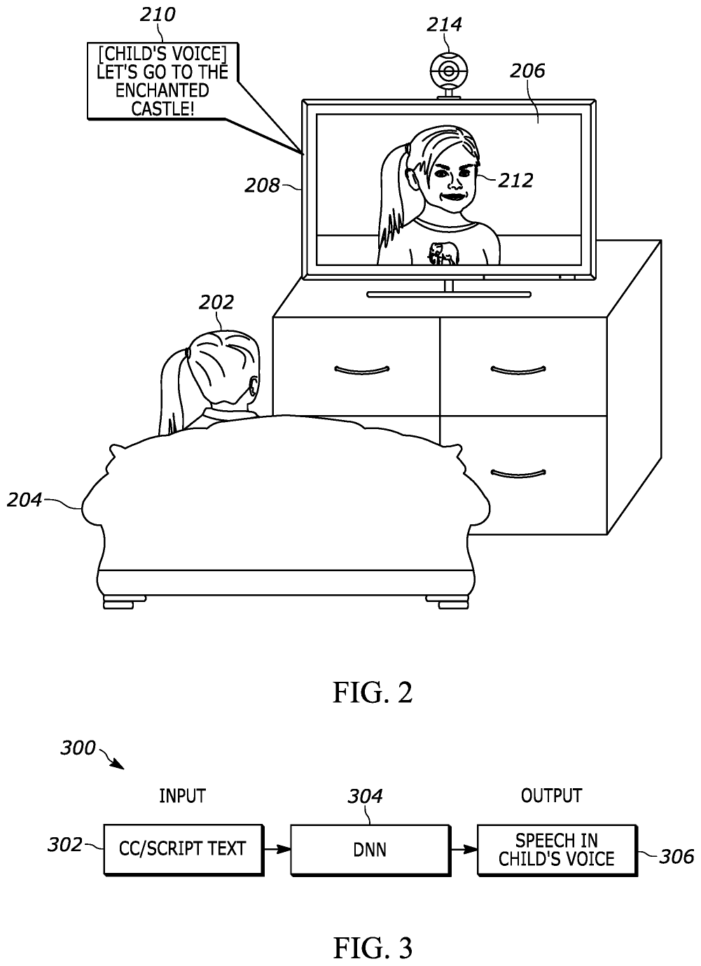

FIG. 2 shows an example illustration 200 in accordance with present principles. As shown, a child 202 that may be under the age of eighteen and even under the age of ten, for example, is shown sitting on a couch 204 while observing audio video (AV) content 206 presented via a television 208, which is one example of a consumer electronics device of an end user in accordance with present principles. The AV content 206 may be a cartoon or other fictional animated content, for example.

As shown by speech bubble 210, audio of one fictional character 212 speaking may be presented, with the character 212 also being visually depicted in video of the AV content. The audio represented by speech bubble 210 may be produced in the voice of the child 202 based on outputs from an artificial intelligence model trained to mimic the child's voice in accordance with present principles.

Furthermore, the audio in the voice of the child may be synchronized to lip movements of the character 212 as visually depicted in the AV content itself so that when the lips or other portions of the mouth of the character 212 are depicted as not moving, no audio is produced in the voice of the child 202, whereas when lips or other portions of the mouth of the character 212 are depicted as moving, audio may be produced in the voice of the child 202.

Further still, the audio in the voice of the child 202 may be synchronized such that various words that are audibly produced in the voice of the child 202 are produced at respective times when corresponding mouth/lip shapes match the shapes associated with the speaking of respective syllables of the words. A relational database of words/syllables and corresponding mouth shapes may be used for such purposes. Facial or objection recognition may also be used to recognize mouth shapes in the AV content. Further still, timing data may also be used that is provided by the content provider and that indicates times during which the character 212 speaks during various points in the AV content and even indicates mouth shapes made by the character 212 during various times in the AV content so that the television 208 may provide associated audio outputs in the voice of the child 202 at those respective times.

Additionally, in some embodiments the likeness of the character 212 may be altered to resemble the likeness of the child 202. For example, a camera 214 on the television 208 may be controlled to gather one or more images of the child 202 and execute object/facial recognition on the images to identify one or more facial characteristics of the child 202, such as sex/gender, skin color, nose shape, eye shape, ear shape, mouth shape, face shape, etc. The character 212 as presented on the television 208 may then be altered to mimic or depict those characteristics, e.g., based on manipulation of the content 206 by a server or other device providing the content to the television 208 (or as may be done by the television 208 itself). This may be done in situations where, for instance, the movements of the character 212 are scripted but the server or television 208 may actually superimpose the character visually within the video component of the content 206 according to the script after rendering a version of the character 212 in conformance with the visual characteristics identified from the child 202. Various graphics processing algorithms and software may therefore be used for such purposes.

FIG. 3 is an example simplified block diagram of a text-to-speech synthesizer 300 according to present principles. The text-to-speech synthesizer 300 may be incorporated into any of the devices disclosed herein, such as the television 208, AVDD 12 and/or server 80 for undertaking present principles. As shown, text 302 may be provided as input to an artificial intelligence model 304 that may be established at least in part by an artificial neural network. For example, the artificial neural network may be a deep neural network (DNN) having multiple hidden layers between input and out layers, and in some embodiments the neural network may even be a deep recurring neural network (DRNN) specifically. The text 302 itself may be text from a written script for AV content, closed captioning text indicating respective words spoken by respective characters in AV content, etc.

As also shown in FIG. 3, the DNN 304 may convert the text 302 into speech 306 as output in the voice of a given child for which the DNN 304 has been trained.

Further describing the DNN 304, in some examples it may include components such as text analysis, prosody generation, unit selection, and waveform concatenation. Also, in some examples, the DNN may specifically be established at least partially by the Acapela DNN (sometimes referred to as “My-Own-Voice”), a text-to-speech engine produced by Acapela Group of Belgium, or equivalent.

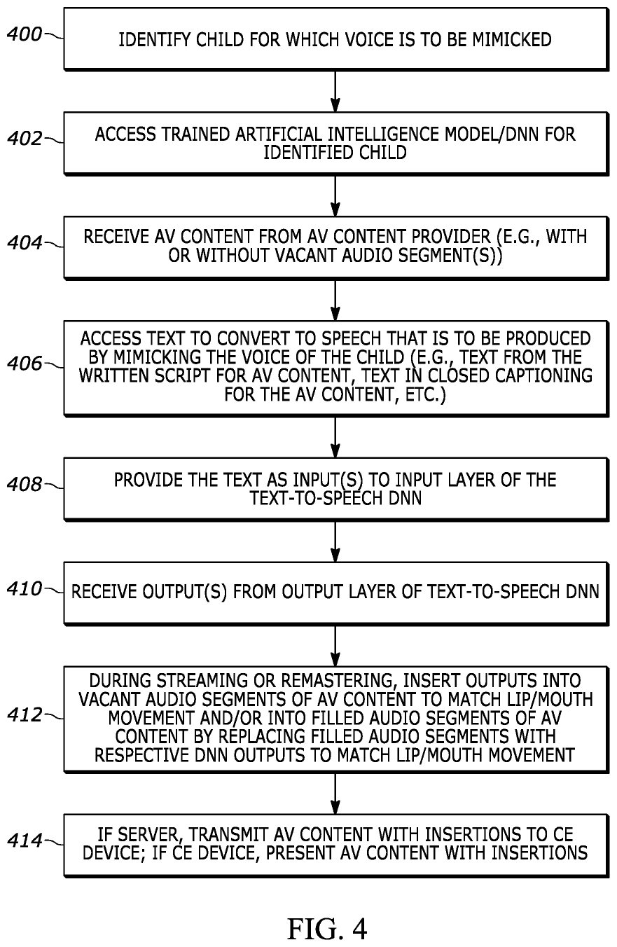

Referring now to FIG. 4, a flow chart of example logic is shown for a device to use an artificial intelligence model such as the model 304 to mimic the voice of a child to output speech in the voice of the child in accordance with present principles. The device executing the logic of FIG. 4 may be any of the devices disclosed herein, such as the television 208, AVDD 12 and/or the server 80.

Beginning at block 400, the device may identify a child whose voice is to be mimicked. This may be done, for example, based on user input from the child or another person indicating the identity (e.g., name) of the child, based on facial recognition of the child using images from a camera on a CE device the child will use to view AV content, etc. Then at block 402 based on identifying the child, the device may access an artificial intelligence model with a DNN already associated with the child and trained to the child's voice. The model may be stored locally at the device undertaking the logic of FIG. 4 (e.g., a CE device), or remotely at another device such as a server.

From block 402 the logic may then proceed to block 404. At block 404 the device may receive or otherwise access AV content from an AV content provider, whether the provider is a server in communication with the device, a cable or satellite TV provider, an Internet streaming service, or a studio or other originator of the AV content itself. For example, the device may stream AV content over the Internet or may receive it via a set top box from a cable TV provider. In some embodiments at block 404, the device may also identify a particular character or temporal audio segments for which the child's voice is to be inserted, e.g., based on user input indicating the character or based on specification by the AV content provider.

In some embodiments, the AV content may be received with vacant audio segments where audio associated with a character from within the AV content would otherwise be present but has been removed or not included so that audio in the voice of the child may be inserted. In some examples, the child or parent may even specify (e.g., via voice or text input) to the content provider a particular character within the AV content for which the child would like to have his or her voice represented, and the content provider may transmit a version of the AV content tailored to not include the original audio of the character so that the tailored version has vacant audio segments in which the child's voice may be inserted. However, note that in other embodiments the AV content may be received with all audio segments filled with original computer-generated voices.

Further describing vacant audio segments, the audio segments themselves may be vacant segments in separate audio tracks, one for each character, that are merged into and presented as one audio stream. Or, the audio segments may be vacant segments within a master audio track or single audio track that presents audio for the AV content itself in a single audio track irrespective of individual characters.

From block 404 the logic may then proceed to block 406 where the device may access text associated with the AV content that is to be converted into speech in the voice of the identified child using the artificial intelligence model accessed at block 402. The text may be closed captioning text associated with the AV content and/or indicating spoken words of the AV content. The text may also be from a manuscript for the AV content (e.g., a screenplay). In either case, the text may be accompanied by or include data indicating times within presentation of the AV content when the speaking occurs. The text may also be accompanied by data indicating pauses in speaking as well as tones and inflections used to speak certain words or certain portions of certain words, etc., as well as timing data indicating times within the AV content at which such things occur.

The logic of FIG. 4 may then continue from block 406 to block 408 where the device may provide, as input to the input layer of the DNN trained to the child's voice, the text and even the associated data indicating pauses, etc. and timing for the pauses as indicated in the preceding sentence. Then at block 410 the device may receive the corresponding speech outputs from the output layer of the DNN corresponding to the text in the voice of the child. The outputs may also conform to the pauses, inflections, etc. and be timed according to the times within the AV content at which such elements of speaking are to occur.

From block 410 the logic may then proceed to block 412. At block 412 the device may insert the outputs from the DNN received at block 410 into vacant or filled audio segments of the AV content to match the lip/mouth movements of the associated character. If vacant audio segments, the device may simply insert them into the audio track based on the timing data at the appropriate place for the character for which the child's voice is to be mimicked, whether the track is a master track or track just for the character for which the child's voice is to be mimicked. If filled audio segments, the original audio for the character that is provided by the content provider may be filtered out using audio processing software along with voice identification to identify the particular character voice to remove, and the audio in the voice of the child may then be inserted into the now-vacant portions of the audio track that have had the original audio filtered out to thus replace the filtered out portions.

Furthermore, note that the device may insert the respective portions of the audio from the output layer of the DNN progressively at the appropriate times during streaming of the AV content, assuming the AV content is being streamed. In some embodiments, the insertion may occur a threshold time before a particular portion of the streaming AV content is to actually be presented, such as five seconds before.

However, in other embodiments the device may insert all audio into all appropriate temporal segments of the AV content prior to presentation of the AV content by remastering the audio track of the AV content to include the speech mimicking the child's voice. The AV content may then be subsequently presented with the master or individual track remastered to include the child's voice.

From block 412 the logic may then proceed to block 414. At block 414, if the device undertaking the logic of FIG. 4 is a server then the device may transmit the AV content to a CE device for presentation at the CE device (e.g., progressively stream the AV content to the CE device during presentation at the CE device, or transmit the entire file of the AV content to the CE device prior to presentation). If the device undertaking the logic of FIG. 4 is the CE device itself, then at block 414 the device may present the AV content with the new audio insertions in the voice of the child.

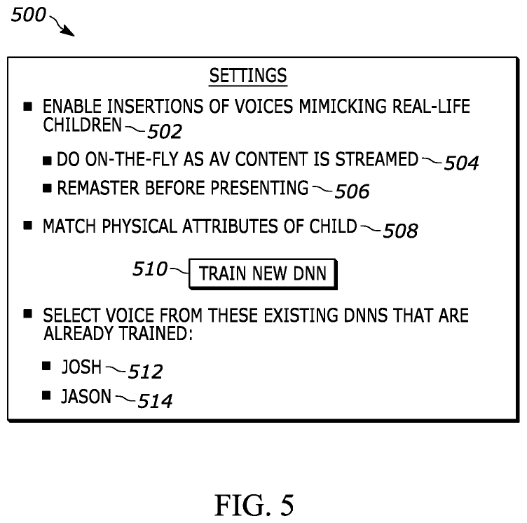

Referring now to FIG. 5, a graphical user interface (GUI) 500 is shown that is presentable on an electronic display that is accessible to a device undertaking present principles. The GUI 500 may be manipulated to configure one or more settings of the device for undertaking present principles. It is to be understood that each of the settings options or sub-options to be discussed below may be selected by directing touch or cursor input to a portion of the display presenting the respective check box for the adjacent option.

As shown, the GUI 500 may include a first option 502 that is selectable to enable the device to undertake present principles for inserting the mimicked voice of a child into AV content. For example, the option 502 may be selectable to enable the device to undertake the logic of FIG. 4. Sub-options 504, 506 may also be presented to respectively insert audio in the voice of a child “on the fly” as AV content is streamed, or by remastering audio for a given piece of AV content before it is presented.

The GUI 500 may also include an option 508 that may be selectable to configure the device to undertake operations to match the physical attributes of a child to a given AV content character, such as visually depicting a character within AV content using certain characteristics of the child as described above in reference to FIG. 2.

The GUI 500 may also include a selector 510 that is selectable to initiate a configuration process for training a DNN to the voice of a child in accordance with present principles. For example, selection of selector 510 using touch or cursor input may initiate a process in which the device may initially establish a DNN by accessing a base copy of the Acapela “My-Own-Voice” DNN produced by Acapela Group of Belgium. Additionally, or alternatively, the device may copy a domain from another text-to-speech engine. The device may then present on a display a series of predefined phrases for the child to speak into a microphone and then record/store the microphone input. The device may also access text corresponding to the predefined phrases. The text/phrases themselves may have been initially provided to the device by a system administrator, for example.

The device may then analyze the respective portions of the recorded speech corresponding to the respective predefined phrases, as well as the corresponding text of the predefined phrases themselves (which may constitute labeling data corresponding to the respective portions of recorded speech in some examples), to train the text-to-speech DNN to the child's voice. The device may train the DNN supervised, partially supervised and partially unsupervised, or simply unsupervised, and may do so at least in part using methods similar to those employed by Acapela Group of Belgium for training its Acapela text-to-speech DNN (“My-Own-Voice”) to a given user's voice based on speech recordings of the user (e.g., using Acapela's first-pass algorithm to determine voice ID parameters to define the parent/guardian's digital signature or sonority, and using Acapela's second-pass algorithm to further train the DNN to match the imprint of the parent/guardian's voice with fine grain details such as accents, speaking habits, etc.)

Still in reference to FIG. 5, the GUI 500 may also include respective options 512, 514 to select respective children's voices in which to present audio for a given character within AV content in accordance with present principles.

It will be appreciated that whilst present principals have been described with reference to some example embodiments, these are not intended to be limiting, and that various alternative arrangements may be used to implement the subject matter claimed herein.

What is claimed is:

1. An apparatus, comprising:
at least one computer memory that is not a transitory signal and that comprises instructions executable by at least one processor to:
access an artificial intelligence model trained to mimic the voice of a child;
access closed captioning (CC) text associated with a piece of audio visual (AV) content; and
use the artificial intelligence model and the CC text to insert audio mimicking the voice of the child into the piece of AV content, the audio comprising an audible representation of the CC text.

2. The apparatus of claim 1, wherein the piece of AV content is an AV cartoon.

3. The apparatus of claim 1, wherein the artificial intelligence model comprises a deep neural network (DNN) trained to mimic the voice of the child, the DNN trained based on recorded speech of the child and text corresponding to the recorded speech.

4. The apparatus of claim 1, wherein the instructions are executable to:
receive the AV content from a content provider; and
insert, locally at the apparatus, the audio into the piece of AV content.

5. The apparatus of claim 4, wherein the apparatus is embodied in a server, wherein the instructions are executable to:
receive the AV content from the content provider with at least one audio segment of the AV content being left vacant; and
transmit, to another device, the piece of AV content with the audio inserted into the at least one vacant audio segment.

6. The apparatus of claim 4, wherein the apparatus is embodied in a server, wherein the instructions are executable to:
receive the AV content from the content provider with no audio segments of the AV content being left vacant; and
transmit, to another device, the piece of AV content with the audio replacing at least a first audio segment of the AV content received from the content provider.

7. The apparatus of claim 4, wherein the apparatus is embodied in a consumer electronics device of an end user, and wherein the instructions are executable to:
receive the AV content from the content provider with at least one audio segment of the AV content being left vacant.

8. The apparatus of claim 7, wherein the instructions are executable to:
remaster the AV content locally at the apparatus prior to presentation of the AV content locally at the apparatus, the AV content being remastered with the audio being inserted into the at least one vacant audio segment; and
subsequently begin presenting the remastered AV content locally at the apparatus.

9. The apparatus of claim 1, wherein the instructions are executable to:
stream the AV content from another device; and
insert the audio into the piece of AV content as the piece of AV content is streamed and presented.

10. The apparatus of claim 9, wherein the apparatus inserts the audio into the piece of AV content as the piece of AV content is streamed and presented by one or more of: inserting the audio into at least one vacant audio segment of the AV content, replacing at least one filled audio segment of the AV content.

11. The apparatus of claim 4, wherein the apparatus is embodied in a consumer electronics device of an end user, and wherein the instructions are executable to:
receive the AV content from the content provider with no audio segments of the AV content being left vacant;
insert the audio into the piece of AV content at least in part by replacing at least a first audio segment of the AV content, the first audio segment being received from the content provider as part of the AV content; and
remaster the AV content locally at the apparatus prior to presentation.

12. The apparatus of claim 1, comprising the at least one processor.

13. A method, comprising:
accessing a speech synthesizer trained to mimic the voice of a child, the speech synthesizer comprising an artificial neural network trained to the child's voice based on recorded speech of the child and first text corresponding to words indicated in the recorded speech;
accessing second text associated with audio visual (AV) content; and
using the speech synthesizer and the second text to insert audio mimicking the voice of the child into the AV content.

14. The method of claim 13, wherein the inserted audio comprises an audible representation of at least a portion of the second text.

15. The method of claim 13, wherein the AV content is animated AV content.

16. The method of claim 13, wherein the inserted audio fills at least one vacant audio segment of the AV content.

17. The method of claim 13, wherein the inserted audio replaces at least one existing audio segment of the AV content.

18. An apparatus, comprising:
at least one computer readable storage medium that is not a transitory signal, the at least one computer readable storage medium comprising instructions executable by at least one processor to:
use a trained deep neural network (DNN) to produce a representation of a child's voice as speaking audio corresponding to at least a portion of the script of audio video (AV) content, the trained DNN being trained using both at least one recording of words spoken by the child and text corresponding to the words, the text being different from the script.

19. The apparatus of claim 18, wherein the AV content is a cartoon.

20. The apparatus of claim 19, wherein the instructions are executable to:
match the representation of the child's voice to lip movement of at least one character visually depicted in the cartoon.
